(19) United States
(12) Patent Application Publication
(10) Pub. No.: US 2009/0193780 A1
(43) Pub. Date: Aug. 6, 2009

(54) Power Generation System for a Marine Vessel

(75) Inventor: Solomon Aladja Faka, Woodland Hills, CA (US)

Correspondence Address: EDELL, SHAPIRO & FINNAN, LLC, 1901 RESEARCH BOULEVARD, SUITE 400, ROCKVILLE, MD, 20850, US

(73) Assignee: WOODSIDE ENERGY LIMITED, Perth (AU)

(21) Appl. No.: 12/399,546

(22) Filed: Mar. 6, 2009

Related U.S. Application Data
(63) Continuation of application No. PCT/AU2007/001322, filed on Sep. 7, 2007.
(60) Provisional application No. 60/843,395, filed on Sep. 11, 2006.

(51) Int. Cl. F02G 3/00; F01K 25/00

(52) U.S. Cl. 60/39.5; 60/671

(57) ABSTRACT

The present invention relates to a power generation system for a marine vessel including a gas-fired power generation unit such as a gas turbine arranged to receive unodorized natural gas that has been vaporized from LNG stored onboard the marine vessel as a source of fuel gas. Unodorized natural gas is used a source of fuel to keep air emissions to a minimum.

### CROSS REFERENCE TO RELATED APPLICATIONS

This application is a continuation of PCT/AU2007/001322, filed Sep. 7, 2007, and titled “Power Generation System for a Marine Vessel,” which claims priority to U.S. Provisional Patent Application Ser. No. 60/843,395, filed on Sep. 11, 2006, the entire contents of which are hereby incorporated by reference.

### FIELD OF THE INVENTION

The present invention relates to a liquefied natural gas (“LNG”) fuelled power generation system for a marine vessel. The present invention relates particularly though not exclusively to a low emission power generation system for a marine vessel.

### BACKGROUND TO THE INVENTION

Natural gas (“NG”) is routinely transported from one location to another location in its liquid state as LNG. Liquefaction of the natural gas makes it more economical to transport as LNG occupies only about 1/600th of the volume that the same amount of natural gas does in its gaseous state. Bulk transportation of LNG from one location to another is most commonly achieved using double-hulled ocean-going vessels with cryogenic storage capability referred to as “LNGCs”. LNG is typically stored in cryogenic storage tanks onboard the LNGC, the storage tanks being operated either at or slightly above atmospheric pressure. The majority of existing LNGCs have an LNG cargo storage capacity in the size range of 120,000 m³ to 150,000 m³, with some LNGCs having a storage capacity of up to 264,000 m³. The temperature within an LNG storage tank will remain constant if the pressure is kept constant and vice versa. This phenomenon is referred to in the art as “auto-refrigeration”. Therefore, whilst LNG storage tanks are heavily insulated to limit the amount of LNG that boils off or evaporates, if some of the boil off gas is not released from the tank, the pressure and temperature within the tank will continue to rise.

It is common for an LNGC to receive its cargo of LNG at an export terminal located in one country and then sail across an ocean to deliver its cargo to an import terminal located in another country. LNG is normally regasified before distribution to end users through a pipeline or other distribution network at a temperature and pressure that meets the delivery requirements of the end users. Upon arrival at the import terminal, the LNGC berths at a pier or jetty and offloads the LNG as a liquid to an onshore storage and regasification facility located at the import terminal. Regasification of the LNG is most commonly achieved by raising the temperature of the LNG above the LNG boiling point for a given pressure. The onshore regasification facility typically comprises a plurality of heat exchangers or vaporisers, pumps and compressors. Such onshore storage and regasification facilities are typically large and the costs associated with building and operating such facilities are significant.

In recent times, environmental standards at import terminals have changed requiring a reduction in the emissions of pollutants from marine vessels in general as well as a reduction in the emissions of pollutants during regasification of LNG to natural gas. Traditional marine diesel oil fired engine technology is also no longer able to meet desirable air quality emission limitations in most developed countries. The present invention was developed to provide a power generation system fuelled by vaporized natural gas with a view to meeting air quality objectives by reducing or controlling emissions of pollutants into the environment.

### SUMMARY OF THE INVENTION

According to one aspect of the present invention there is provided a power generation system for a marine vessel including a gas-fired power generation unit arranged to receive unodorized natural gas that has been vaporized from LNG stored onboard the marine vessel as a source of fuel gas, the power generation system further comprising an emission reduction system for treating the exhaust gases from the gas-fired power generation unit.

In one form, a source of fuel gas for the gas-fired power generation unit is boil-off gas removed from an LNG storage tank onboard the marine vessel. When the marine vessel includes an onboard regasification facility for vaporizing LNG to produce natural gas, a source of fuel gas for the gas-fired power generation unit in another form of the present invention is a stream of vaporized LNG generated by the onboard regasification facility. Advantageously, the power generation system may share power between a propulsion plant for moving the marine vessel from one location to another location and an onboard regasification facility for vaporizing LNG to produce natural gas.

In one form the emission reduction system includes a catalyst for removing at least one pollutant from the exhaust gas generated in use by the gas-fired power generation unit, the pollutant selected from the group consisting of: (a) nitrogen oxide; (b) particulates less than 10 micrometers in diameter; (c) volatile organic compounds; (d) sulfur dioxide (SOx); and, (e) carbon monoxide (CO), alone or in combination. In one form, the emission reduction system removes at least 95% of the nitrogen oxide from the exhaust gas or at least 90% of the volatile organic compounds from the exhaust gas or removes 25 to 70% of the carbon monoxide from the exhaust gas or removes 20 to 70% of particulates less than 10 micrometers in diameter from the exhaust gas.

In one form, the emission reduction system comprises a catalytic converter. In another form, the emission reduction system comprises a catalytic converter and an absorption catalyst in series. To reduce NOx emissions in the exhaust gas, the gas-fired power generation unit may be fitted with a pre-mixer combustion system for regulating the air/fuel gas mixture fed to the gas-fired power generation unit such that the air/fuel gas mixture is lean.

When boil-off gas from an LNG storage tank is used as a source of fuel gas for the gas-fired power generation unit, boil-off gas which is excess to the fuel gas requirements of the power generation system may be diverted to an onshore gas delivery system. In another form, a boil off gas generator for vaporizing LNG stored onboard the marine vessel may be used to produce forced boil off gas as a supplementary source of fuel gas to the power generation system.

In one form of the present invention, the power generation system further comprises a heat recovery system for generating steam to drive a stream turbine to provide supplementary power to the power generation system. Advantageously, the heat recovery system may be used to provide supplementary heat for vaporizing LNG stored onboard the marine carrier to produce natural gas.

To prevent formation of hydrocarbon condensate, the unodorized natural gas is directed to flow through a fuel gas conditioning unit to heat and pressurize the fuel gas prior to introduction of the unodorized natural gas to the gas-fired power generation unit. The gas conditioning unit comprises a compressor for pressurizing the gas and a temperature regulator to increase the temperature of the fuel gas prior to compression and combustion. The temperature regulator may use electrical heating, steam heating, or heat exchange with a circulating intermediate fluid as a source of heat for adjusting the temperature of the unodorized natural gas.

In one form, the marine vessel includes an onboard regasification facility for vaporizing LNG to produce natural gas, and the onboard regasification facility comprises one or more air fin vaporizers for exchanging heat between forced or natural draft ambient air and a circulating intermediate fluid. The air fin vaporizers may advantageously be used for either heating the intermediate fluid which in turn is used to transfer heat to vaporize LNG during regasification operations, or for cooling the intermediate fluid after the intermediate fluid has been used to recover heat from the exhaust gas of the gas-fired power generation unit.

In one form of the present invention, the air supplied to the gas-fired power generation unit is subjected to pre-cooling using an intermediate fluid circulating through an onboard regasification facility.

The unodorized natural gas that has been vaporized from LNG stored onboard the marine vessel may be used as the sole or predominant source of fuel gas to the gas-fired power generation unit whenever LNG is stored onboard the marine vessel to keep emissions of SOx to a minimum.

Preferably, the gas-fired power generation unit is a gas turbine.

### BRIEF DESCRIPTION OF THE DRAWINGS

In order to facilitate a more detailed understanding of the nature of the invention several embodiments of the present invention will now be described in detail, by way of example only, with reference to the accompanying drawings, in which:

FIG. 1 is a schematic side view of a power generation plant provided on a marine vessel in the form of an LNG carrier fitted with a propulsion plant and an onboard regasification facility;

FIG. 2 illustrates one embodiment of a flow diagram for the supply of natural boil off gas from LNG stored onboard the marine vessel of FIG. 1 to the power generation plant;

FIG. 3 illustrates another embodiment of a flow diagram for the supply of forced boil off gas vaporized from LNG stored onboard the marine vessel of FIG. 1 to the power generation plant;

FIG. 4 illustrates yet another embodiment of a flow diagram for the supply of natural gas vaporized from LNG stored onboard the marine vessel using the onboard regasification facility onboard the marine vessel of FIG. 1 to the power generation plant;

FIG. 5 illustrates one embodiment of the power generation system that is provided with a pre-mixer combustion unit and an emission reduction system for treating the exhaust gases from the gas turbines to remove pollutants; and,

FIG. 6 illustrates another embodiment of the power generation system that is provided with an emission reduction system for treating the exhaust gases from the gas turbines to remove pollutants.

### DETAILED DESCRIPTION OF PREFERRED EMBODIMENTS

Particular embodiments of a power generation system for a marine vessel are now described in the context of the marine vessel being an LNG carrier fitted with both a propulsion plant and an onboard regasification facility. The present invention is equally applicable to LNG carriers which are not provided with an onboard regasification facility. It is to be further understood that the present invention is not limited to use onboard an LNG carrier, but is equally applicable to any marine vessel which carries LNG in an storage tank onboard the vessel, for example a cruise ship or a support or supply vessel. The terminology used herein is for the purpose of describing particular embodiments only, and is not intended to limit the scope of the present invention. Unless defined otherwise, all technical and scientific terms used herein have the same meanings as commonly understood by one of ordinary skill in the art to which this invention belongs. Like reference numerals refer to like parts in relation to all of the Figures. Not all pumps, valves and other control elements have been shown in the Figures in the interest of simplicity.

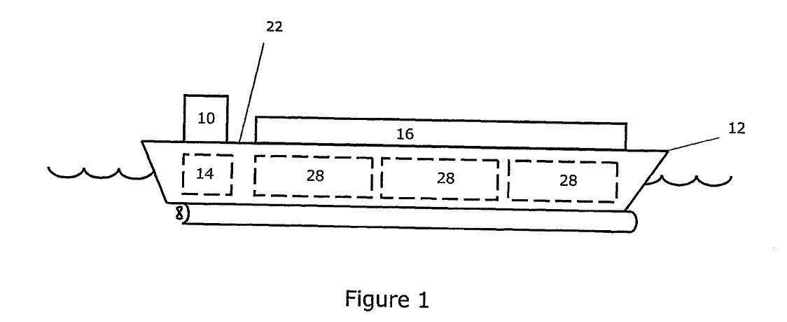

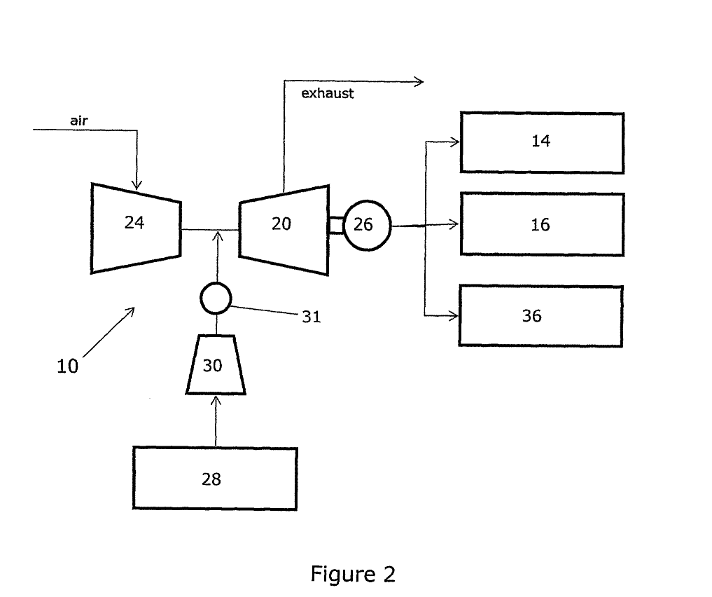

A first embodiment of the power generation system 10 of the present invention is now described with reference to FIGS. 1 and 2. The marine vessel 12 in this embodiment is an LNG carrier provided with a propulsion plant 14 for moving the LNG carrier from one location to another location and an onboard regasification facility 16 for vaporizing LNG to produce natural gas when the LNG carrier 12 is moored at an offloading location. The power generation system 10 include a gas-fired power generation unit 20, in this example a gas turbine arranged to use unodorized natural gas that has been vaporized from LNG stored onboard the marine vessel 12 as a source of fuel gas. The number and arrangement of gas turbines 20 used in the power generation system 10 depends on the anticipated maximum load required from the power generation system 10 which in turn depends on a number of design variables. The gas turbines 20 are preferably located on an upper deck 22 or in an engine room (not shown) of the LNG carrier 12 for optimum safety.

With reference to FIG. 2, the gas turbine 20 produces energy by combustion of a source of fuel gas (in this case unodorized vaporized natural gas) mixed with intake air from an air compressor 24. The hot combustion gases are directed to flow across the blades (not shown) of the gas turbine 20, causing the turbine to spin providing rotation to a mechanical shaft to drive a first generator 26. Additional thrust can be provided by acceleration of the combustion gases through a nozzle (not shown).

During combustion of any fuel gas, pollutants are produced which report to the exhaust gas. The quantity and type of pollutant produced in the exhaust gas depends on such relevant factors as the efficiency of combustion, the degree of air compression, the air-to-fuel ratio, the inlet temperature of the compressed air and the fuel gas, the humidity of the inlet air, ignition timing, efficiency of combustion and the type of fuel gas supplied to the gas turbine. In order to keep emissions to a minimum, the power generation system 10 of the present invention uses unodorized natural gas that has been vaporized from LNG stored onboard the marine vessel 14 as the source of fuel gas to the gas-fired power generation equipment 20. The only time when an alternative source of fuel such as marine diesel oil is used as a source of fuel for the marine vessel is when the level of LNG stored onboard the marine vessel 14 is insufficient to operate the gas-fired power generation unit 20.

Prior to liquefaction, wellhead gas is subjected to initial separation to remove particulates, free water, and condensate before being subjected to gas conditioning to remove acid gases (including carbon dioxide and hydrogen sulfide). The gas is then subjected to drying to reduce the water content, typically to a level below 50 parts per million. The dry gas is then subjected to further processing to remove mercury and heavy hydrocarbons. The final stage of conditioning involves removal of the liquefied petroleum gas (LPG) prior to liquefaction. Consequently, use of the natural gas produced from vaporized LNG as a source of fuel to the gas turbine 20 of the power generation system 10 of the present invention, produces a lower level of emissions and pollutants than would be produced by burning oil or coal to fire the burners of a traditional prior art steam turbine driven LNG carrier. Natural gas which is generated during vaporization of LNG is “unodorized” in that sulfur compounds are removed from well head gas prior to liquefaction. In contrast, pipeline natural gas sourced from an onshore gas distribution facility includes a sulfur containing odorant which is deliberately added to gas intended for use by consumers prior to distribution for the purpose of facilitating detection of leaks. The use of “unodorized” vaporized LNG leads to a reduction in the level of sulfur dioxide produced in the exhaust gas from the gas turbine 20 of the present invention. LNG also does not contain heavy hydrocarbons (which have been removed during gas conditioning prior to liquefaction) and this leads to reduction in the particulates present in the exhaust gas produced by the gas turbine 20 of the present invention compared with a gas turbine operated using odorized natural gas from an onshore gas distribution facility.

LNG is stored onboard the LNG carrier 12 in one or more insulated cryogenic storage tanks 28. The storage tanks can be membrane tanks or Moss-style tanks or prismatic tanks. The insulation on the LNG storage tanks 28 allows some of the LNG to warm over time and return to its gaseous form (a process referred to in the art as “boil off”). The LNG storage tanks 28 are operated in such a manner as to maintain a fairly constant tank pressure by removal of the boil off gas. Removal of the boil off gas allows the remaining LNG to be maintained at a constant cold temperature in its liquid form. An average of approximately 0.15 percent of the LNG will boil off each day under normal operating conditions.

The unodorized natural gas is used as one of the sources of fuel for the gas turbines 20 of the present invention is derived from one or more of the following sources: a) natural boil off gas from the LNG storage tanks 28; b) forced boil off gas from the LNG storage tanks 28; and, c) LNG vaporized to natural gas using the onboard regasification facility 16. Each of these options is described in greater detail below.

In the embodiment illustrated in FIG. 2, the source of fuel gas to the gas turbine 20 is natural boil off gas from an LNG storage tank 28 onboard the LNG carrier 12. The boil off gas is directed to flow through a fuel gas conditioning unit 30 to heat and pressurize the boil off gas prior to combustion. The fuel gas conditioning unit 30 comprises a compressor for pressurizing the gas to a pressure level suitable for supply as a fuel gas to the gas turbine 20 and a temperature regulator 31 for measuring and adjusting the temperature of the boil off gas, as required, to increase the temperature of the fuel gas prior to compression and combustion. Heat is supplied to the temperature regulator 31 using electrical heating, steam heating, or by circulating a warm intermediate fluid.

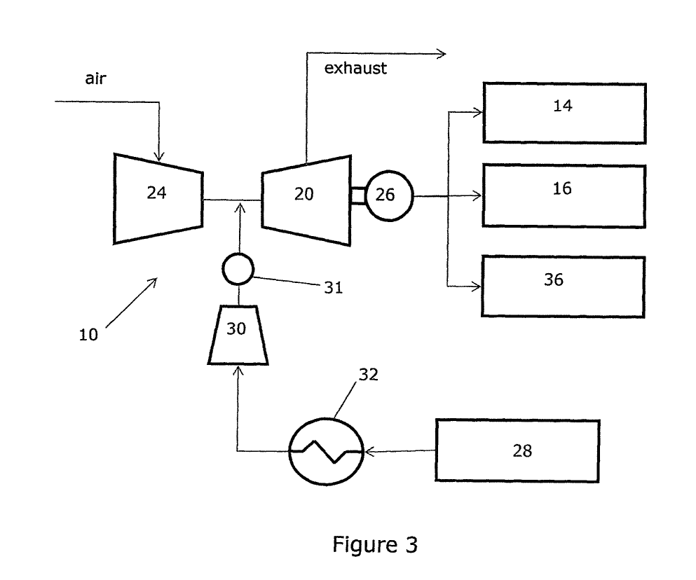

With reference to the embodiment illustrated in FIG. 3, if, when the LNG carrier 12 is underway, the quantity of boil off gas produced by heat ingress to the LNG storage tanks 28 alone is not sufficient to meet the required fuel gas demand of the power generation system 10, additional “forced” boil off gas can be generated by vaporization of a small quantity of LNG in a boil off gas generator 32 as illustrated in FIG. 3. Heat is supplied to the boil off gas generator 32 to vaporize a stream of LNG using electrical heating, steam heating or by circulating a warm intermediate fluid. The forced boil off gas is directed to flow through a fuel gas conditioning unit 30 to heat and pressurize the boil off gas prior to its introduction to the gas turbine 20. As above, the fuel gas conditioning unit 30 can be provided with temperature regulator 31 for measuring and adjusting the temperature of the forced boil off gas, as required. Heat is supplied to the temperature regulator 31 using electrical heating, steam heating, or by circulating a warm intermediate fluid.

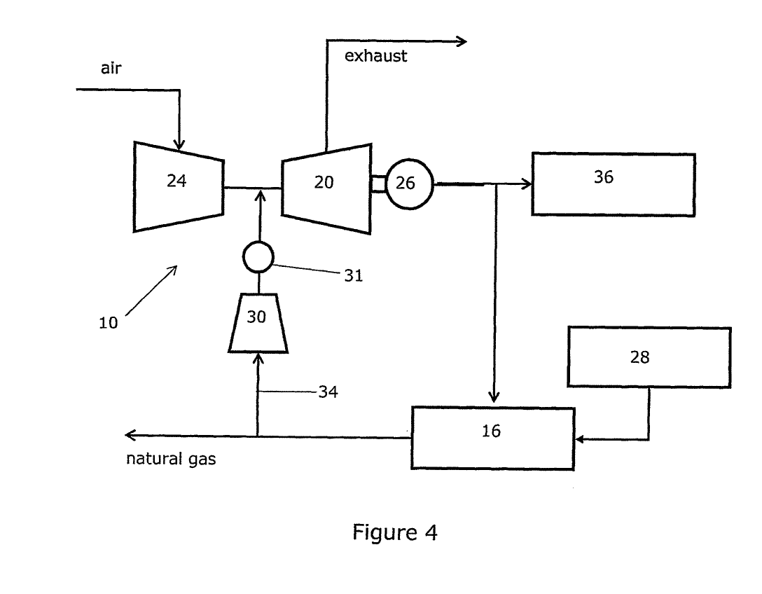

With reference to the embodiment illustrated in FIG. 4, when the LNG carrier 12 is moored at the offloading location, LNG from the storage tanks 28 onboard the marine vessel 14 is vaporized to natural gas using the onboard regasification facility 16. In this embodiment, a bypass stream 34 of the natural gas produced by the onboard regasification facility 16 is directed to the power generation system 10 to act as the source of fuel gas to the gas turbine 20. The bypass stream 34 is directed to flow through a fuel gas conditioning unit 30 to pressurize the vaporized gas to a pressure level suitable for supply as a fuel gas to the gas turbine 20. The fuel gas conditioning unit 30 can be provided with temperature regulator 31 for measuring and adjusting the temperature of the vaporized gas, as required, to improve the combustion efficiency of the gas turbine 20. Heat is supplied to the temperature regulator 31 using electrical heating, steam heating, or by circulating a warm intermediate fluid.

In the embodiments illustrated in FIGS. 2 and 3, the power generation system 10 is configured to share power between the propulsion plant 14 as and the onboard regasification facility 16 as well as providing power to other ship services and utilities 36, including the electrical utility systems, the crew and cargo systems and associated pumps, fans or other equipment associated with the onboard regasification facility, the lighting systems, the accommodation unit, communications systems, inert gas and nitrogen generation systems, air supply systems, water systems, and waste treatment. The power generation system 10 provides power to the onboard regasification facility 16 when the LNG carrier 12 is moored at an offloading location at a time when the power requirements of the propulsion plant 14 are at a minimum or zero. In an analogous fashion, the power generation system 10 provides power to the propulsion plant 14 when the LNG Carrier 12 is moving from one location to another location, for example, when the LNG Carrier is in transit from an export terminal to the offloading location or travelling to a dry dock for inspection or repairs. Integration of the power generation system minimizes duplication, since the regasification facility is not operational while the vessel is underway.

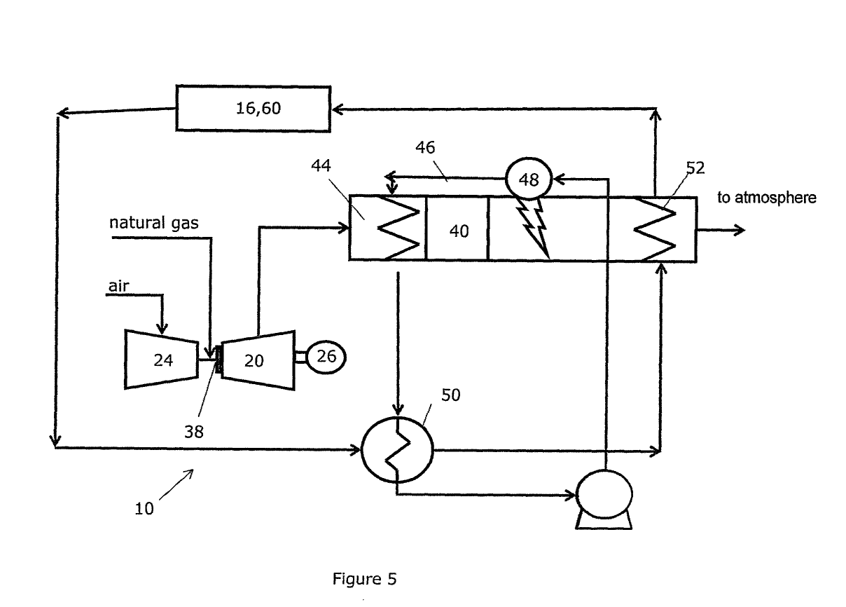

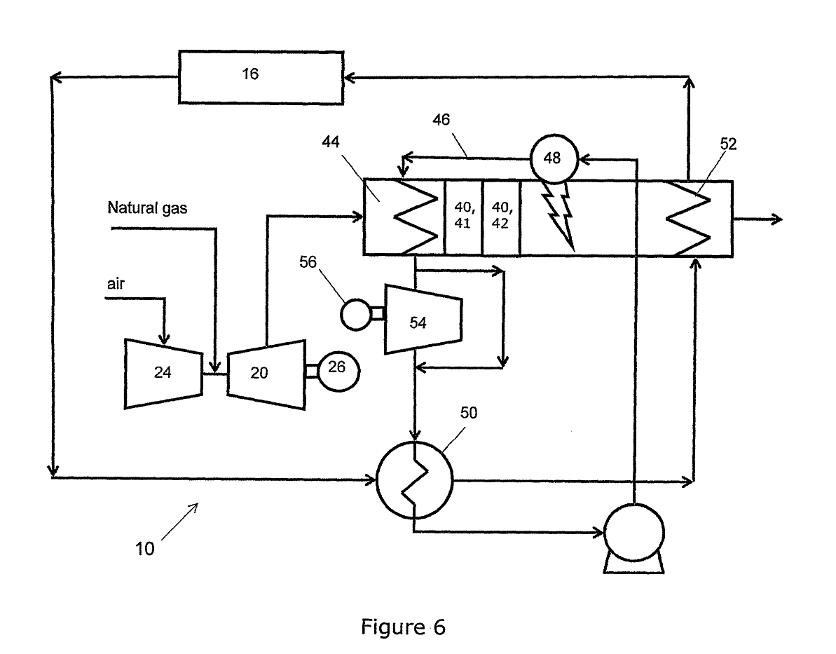

In the embodiments illustrated in FIGS. 5 and 6, the power generation system 10 is provided with an emission reduction system 40 for treating the exhaust gases from the gas-fired power generation equipment 20 to remove pollutants. The term “NOx” is used in the relevant art to refer to oxides of nitrogen which principally form during combustion of air and a fuel gas through thermal reaction of nitrogen and oxygen present in the air. The type of NOx present as a pollutant in the exhaust gases after combustion is a function of the combustion temperature and the air to fuel ratio. The term “Sox” is used in the relevant art to refer to oxides of sulfur, principally sulfur dioxide, which is present as a pollutant in an exhaust gas due to thermal reaction of sulfur compounds present in the fuel gas and oxygen present in the air. Carbon monoxide may also be present in exhaust gas as a pollutant due to incomplete combustion. Other pollutants present in the exhaust gas include a wide spectrum of volatile organic compounds (referred to in the art by the term “VOC”), that are photoreactive in the atmosphere. VOC emissions are produced as a result of incomplete combustion or as pyrolysis products of other heavier hydrocarbon constituents present in the fuel. Particulate matter emissions (referred to in the art as “PM”) in exhaust gas can include trace amounts of metals, non-combustible inorganic material, and carryover of noncombustible trace constituents from a fuel gas or from a lubricating oil. Increased PM emissions can be caused by poor air-to-fuel mixing, spikes in loading, or maintenance problems.

The post-combustion emission reduction system 40 used for the system and process of the present invention is capable of removing one or more pollutants selected from the group consisting of: nitrogen oxides (NOx), particulates less than 10 micrometers in diameter (PM10), volatile organic compounds (VOC), sulfur dioxide (SOx), and carbon monoxide (CO) from the exhaust gas. To achieve target emission reduction control limits, the emission reduction system is configured to be capable of removing at least 95% of the nitrogen oxide, and/or at least 90% of the volatile organic compounds, 25-70% of the carbon monoxide and/or 20-70% of the particulates less than 10 micrometers in diameter (PM10) from the exhaust gas.

The emission reduction system 40 may rely on one or more of the following alone or in combination: a catalytic conversion process; a selective catalytic reduction (SCR) process; an oxidation catalyst; a NOx reduction catalyst; an absorption catalyst; or an adsorption catalyst. An oxidation catalyst is an absorption-type catalyst which is particularly suited to the removal of carbon monoxide emissions from the exhaust gases which are directed to flow over a catalyst which oxidizes the carbon monoxide present in the exhaust gas to produce carbon dioxide. SCR is particularly suited to the reduction of NOx emissions from an exhaust gas. SCR relies on the injection of a suitable dose of aqueous urea or ammonia (anhydrous ammonia or aqueous ammonium hydroxide) into the exhaust gas upstream of an catalyst to act as a reducing agent. The oxides of nitrogen present in the exhaust gas react with ammonia and oxygen on the surface of the catalyst to form nitrogen (N2) and water (H2O). Maximum catalyst performance is achieved when the temperature of the exhaust gas fed to the catalyst falls within a specific target range which is a function of the type of catalyst being used. An SCR system is best suited for use on an engine which is operated at essentially constant loads.

With reference to the embodiment illustrated in FIG. 6, the emission reduction system 40 comprises a combination of a selective catalytic emission reduction unit 41 located at the exhaust uptake of the gas turbine to effect an initial reduction in the load of NOx emissions fed to a downstream absorption-type catalyst unit 42, which is used to further reduce the level of pollutants in the exhaust gas. This arrangement is used to take advantage of the ability of a selective catalytic emission reduction unit 41 to treat a high concentration of NOx emissions combined with the ability of an absorption-type catalyst 42 to remove other pollutants from the exhaust gas which now has a reduced concentration of NOx. The advantage of this two stage process over the use of any of the emission reduction technologies used alone is that it combines the best attributes of both technologies to achieve ultra low emissions levels. Advantageously, the absorption catalysts take longer to become saturated which leads to a reduction in operating costs and can reduce the risk of catalyst poisoning.

In another embodiment illustrated in FIG. 5, a lean-burn gas power generation unit 20 is used in that the gas turbine 20 is fitted with a pre-mixer combustion system 38 for regulating the air/fuel gas mixture fed to the gas turbine 20 such that the air/fuel gas mixture is sufficiently lean as to reduce NOx emissions in the exhaust gas. Using the pre-mixer combustion system 38, the air and the fuel gas are pre-mixed prior to introduction into the combustion chamber of the gas-fired power generation unit 20. In this way, the use of a selective catalytic combustion unit can be avoided. When lean-burn gas-fired power generation units 20 are used for the system of the present invention, the level of carbon monoxide emissions in the exhaust may be higher than the level of carbon monoxide emissions generated using a higher air to fuel ratio. The exhaust gas from the gas turbine 20 is directed to flow through an absorption-type catalyst system 42 to remove NOx, VOC, SOx, CO and PM10 from the exhaust gas. The pollutant reduction efficiency of an absorption-type catalyst is dependent in part on the residence time of the flow of gas through the catalyst bed. With a short residence time, the outlet pollutant concentration of the exhaust gas treated using an absorption-type catalyst can be reduced to very low levels compared to what is achievable using SCR alone. Maximum catalyst performance is achieved when the temperature of the exhaust gas fed to the catalyst falls within a specific target range which is a function of the type of catalyst being used.

To regulate the temperature of the exhaust gas fed to the post-combustion emission reduction system 40, the hot exhaust gas from the gas turbine 20 is cooled to a target inlet temperature range before the exhaust gas is allowed to enter the emission reduction system 40. With reference to the embodiment illustrated in FIG. 5, the hot exhaust gas which exits the gas turbine 20 is directed to flow through a first heat recovery unit 44 used to reduce the temperature of the exhaust gas to temperature within a target inlet temperature range for the absorption catalyst system 42. The target inlet temperature range is selected to maximize the life of the catalyst within the absorption-type catalyst system 42. The cooled exhaust gas then enters the emission reduction system 40 which is arranged to remove NOx, VOC, SOx, CO and PM10 from the exhaust gas as described above.

Downstream of the emission reduction system 40, the exhaust gas is subjected to further cooling through heat exchange with a heat transfer fluid, such as boiler feed water, using a waste heat boiler 48 to produce a stream of low pressure steam 46. In the first heat recovery unit 44 upstream of the absorption-type catalyst system 42, heat is transferred from the hot exhaust gas to the stream of low pressure steam 46 generated by the waste heat boiler 48. In the embodiment illustrated in FIG. 5, the high pressure steam which exits the first heat recovery unit 44 is directed to a steam condenser 50 in which the high pressure steam condenses to form a condensate which is de-aerated if desired before being recycled to the waste heat boiler 48.

During its passage through the steam condenser 50, the high pressure steam from the first heat recovery unit 44 exchanges heat with a circulating intermediate fluid. The circulating intermediate fluid enters the steam condenser 50 as cool intermediate fluid and exits the steam condenser 50 as warm intermediate fluid. If the temperature of exhaust gas downstream of the waste heat boiler 48 is higher than the temperature of the warm intermediate fluid downstream of the steam condenser 50, additional heat can be recovered from the exhaust gas through heat exchange with the warm intermediate fluid, if desired, by passing the exhaust gas through a second heat recovery unit 52. Suitable intermediate fluids include formate, glycol, propane, sea water or fresh water or any other fluid with an acceptable heat capacity and boiling point that is commonly known to a person skilled in the art.

In the embodiment illustrated in FIG. 6, the high pressure steam which exits the first heat recovery unit 44 is used to drive a steam turbine 54 causing the turbine to spin providing rotation to a mechanical shaft to drive a second generator 56. In an analogous manner to the first generator 26, the second generator 56 is arranged to share power between the propulsion plant 14 of the LNG carrier, the onboard regasification facility 16, and the ship services and associated equipment 36. The pressure of the steam is reduced during its passage through the steam turbine 54 and exits the steam turbine 54 as a stream of low pressure steam which is condensed as it passes through the condenser 50 in the manner described above for the embodiment illustrated in FIG. 5.

When the LNG carrier 12 is fitted with an onboard regasification facility 16 and the LNG carrier 12 is conducting regasification operations, the warm intermediate fluid which has passed through the steam condenser 50 and, optionally, the second heat recovery unit 52, can be circulated through the onboard regasification facility 16 to provide a source of heat for use in the vaporization of LNG to natural gas during regasification operations. The stream of cool intermediate fluid which is returned from the onboard regasification facility 16 is then recirculated through the steam condenser 50 and the second heat recovery unit 52 to recover heat from the exhaust gas in the manner described above.

It is to be understood that while the onboard regasification facility 16 can use a variety of other sources of heat for vaporization of LNG, the use of forced or natural draft ambient air as a primary source of heat for vaporization of LNG onboard the marine vessel 12 is preferred to keep emissions to a minimum compared with other regasification technologies that rely on the use of seawater or the burning of liquid fuels as the primary heat source for vaporization. Advantageously, when the onboard regasification facility 16 comprises one or more air fin vaporizers 60, the warm intermediate fluid can be circulated through the one or more air fin vaporizers for cooling of the intermediate fluid using forced or natural draft ambient air when the LNG carrier 12 is not performing regasification operations or is underway. In this way the air fin vaporizers serve as heat exchangers with essentially two independent functions—a) heating of LNG during regasification operations, and b) cooling of a circulating intermediate fluid at all other times.

Now that several embodiments of the invention have been described in detail, it will be apparent to persons skilled in the relevant art that numerous variations and modifications can be made without departing from the basic inventive concepts. By way of example, the air supplied to the gas turbine 20 air compressor 24 can be pre-cooled to improve performance, for example using the cooled circulating intermediate fluid returning from the onboard regasification facility 16. In an analogous manner, the fuel gas fed to the gas-fired power generation unit 20 can be pre-heated to improve efficiency and reduce emissions using heat recovered from the exhaust gas by the circulating intermediate fluid, heating using low pressure or high pressure steam, or electric heating using power from the first or second generator 26 or 56, respectively. All such modifications and variations are considered to be within the scope of the present invention, the nature of which is to be determined from the foregoing description and the appended claims.

All of the patents cited in this specification, are herein incorporated by reference. It will be clearly understood that, although a number of prior art publications are referred to herein, this reference does not constitute an admission that any of these documents forms part of the common general knowledge in the art, in Australia or in any other country. In the summary of the invention, the description and claims which follow, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A power generation system for a marine vessel including a gas-fired power generation unit arranged to receive unodorized natural gas that has been vaporized from LNG stored onboard the marine vessel as a source of fuel gas, further comprising an emission reduction system for treating the exhaust gases from the gas-fired power generation unit.

2. The power generation system of claim 1 wherein a source of fuel gas for the gas-fired power generation unit is boil-off gas removed from an LNG storage tank onboard the marine vessel.

3. The power generation system of claim 1 wherein the marine vessel includes an onboard regasification facility for vaporizing LNG to produce natural gas and a source of fuel gas for the gas-fired power generation unit is a stream of vaporized LNG generated by the onboard regasification facility.

4. The power generation system of claim 3 wherein the power generation system shares power between a propulsion plant for moving the marine vessel from one location to another location and an onboard regasification facility for vaporizing LNG to produce natural gas.

5. The power generation system of claim 1 wherein the emission reduction system includes a catalyst for removing at least one pollutant from the exhaust gas generated in use by the gas-fired power generation unit, the pollutant selected from the group consisting of: (a) nitrogen oxide; (b) particulates less than 10 micrometers in diameter; (c) volatile organic compounds; (d) sulfur dioxide (SOx); and, (e) carbon monoxide (CO), alone or in combination.

6. The power generation system of claim 1 wherein the emission reduction system removes at least 95% of the nitrogen oxide from the exhaust gas.

7. The power generation system of claim 1 wherein the emission reduction system removes at least 90% of the volatile organic compounds from the exhaust gas.

8. The power generation system of claim 1 wherein the emission reduction system removes 25 to 70% of the carbon monoxide from the exhaust gas.

9. The power generation system of claim 1 wherein the emission reduction system removes 20 to 70% of particulates less than 10 micrometers in diameter from the exhaust gas.

10. The power generation system of claim 1 wherein the emission reduction system comprises a catalytic converter.

11. The power generation system of claim 1 wherein the emission reduction system comprises a catalytic converter and an absorption catalyst in series.

12. The power generation system of claim 1 wherein boil-off gas from an LNG storage tank is used as a source of fuel gas for the gas-fired power generation unit, and wherein boil-off gas which is excess to the fuel gas requirements of the power generation system is diverted to an onshore gas delivery system.

13. The power generation system of claim 1 further comprising a boil off gas generator for vaporizing LNG stored onboard the marine vessel to produce forced boil off gas as a supplementary source of fuel gas to the power generation system.

14. The power generation system of claim 1 wherein the gas-fired power generation unit is fitted with a pre-mixer combustion system for regulating the air/fuel gas mixture fed to the gas-fired power generation unit such that the air/fuel gas mixture is lean so as to reduce NOx emissions in the exhaust gas.

15. The power generation system of claim 1 further comprising a heat recovery system for generating steam to drive a stream turbine to provide supplementary power to the power generation system.

16. The power generation system of claim 1 further comprising a heat recovery system for proving supplementary heat for vaporizing LNG stored onboard the marine carrier to produce natural gas.

17. The power generation system of claim 1 wherein the unodorized natural gas is directed to flow through a fuel gas conditioning unit to heat and pressurize prior to introduction of the unodorized natural gas to the gas-fired power generation unit.

18. The power generation system of claim 17 wherein the fuel gas conditioning unit includes a temperature regulator for measuring and adjusting the temperature of the unodorized natural gas prior to introduction of the unodorized natural gas to the gas-fired power generation unit, and wherein the temperature regulator uses electrical heating, steam heating, or heat exchange with a circulating intermediate fluid as a source of heat for adjusting the temperature of the unodorized natural gas.

19. The power generation system of claim 1 wherein the marine vessel includes an onboard regasification facility for vaporizing LNG to produce natural gas and wherein the onboard regasification facility comprises one or more air fin vaporizers for exchanging heat between forced or natural draft ambient air and a circulating an intermediate fluid.

20. The power generation system of claim 19 wherein the air fin vaporizers are arranged either (i) for heating the intermediate fluid which in turn is used to transfer heat to vaporize LNG during regasification operations, or (ii) for cooling the intermediate fluid after the intermediate fluid has been used to recover heat from the exhaust gas of the gas-fired power generation unit.

21. The power generation system of claim 1 wherein the air supplied to the gas-fired power generation unit is subjected to pre-cooling using an intermediate fluid circulating through an onboard regasification facility.

22. The power generation system of claim 1 wherein the unodorized natural gas that has been vaporized from LNG stored onboard the marine vessel is the sole source of fuel gas to the gas-fired power generation unit whenever LNG is stored onboard the marine vessel.

23. The power generation system of claim 1 wherein the gas-fired power generation unit is a gas turbine.
